(19) United States
(12) Patent Application Publication
(10) Pub. No.: US 2003/0002627 A1
(43) Pub. Date: Jan. 2, 2003

(54) Cold emitter x-ray tube incorporating a nanostructured carbon film electron emitter

(75) Inventors: Robert J. Espinosa, Campbell, CA (US); Bradley W. Boyer, Scotts Valley, CA (US); Scott Snyder, Mountain View, CA (US); Majorie L. Munson, Santa Cruz, CA (US); Ken G. Gorman, Ben Lomond, CA (US)

Correspondence Address: Jeffrey A. Hall, 212 Clinton Street, Santa Cruz, CA, 95062, US

(73) Assignee: Oxford Instruments, Inc.

(21) Appl. No.: 10/224,008

(22) Filed: Aug. 20, 2002

Related U.S. Application Data
(63) Continuation-in-part of application No. 09/699,823, filed on Oct. 30, 2000.
(63) Continuation-in-part of application No. 09/699,822, filed on Oct. 30, 2000.
(60) Provisional application No. 60/236,097, filed on Sep. 28, 2000.

(51) Int. Cl. H01J 35/06

(52) U.S. Cl. 378/136

(57) ABSTRACT

A cold emitter x-ray tube is provided comprised of a cathode which is a carbon nanotube or nanostructured carbon film which serves as the electron emission source in an x-ray tube, and is positioned on a suitable substrate. The nanostructured carbon film is selected from a group consisting of nanocyrstalline graphite, carbon nanotubes, diamond, diamond like carbon, or a composite of two or more of members of the group. An extraction/suppression grid may be utilized. A metal anode which functions as the x-ray generating target is positioned within the x-ray tube. A high voltage source with negative contact is connected to the emitter and the positive contact connected to the anode target. This single source of high potential serves to provide the electric field, between the emitter and anode, for extraction of electrons from the emitter and to accelerate the electrons to the target for generation of x-rays. X-rays pass through a beryllium window that is an integral part of the vacuum envelope. The x-ray tube may be used for various applications such as portable x-ray spectrometry, portable fluoroscopy, radiation treatment, and the like.

### CROSS-REFERENCE TO RELATED APPLICATIONS

This application is a continuation-in-part of and claims priority from co-pending U.S. patent application Ser. No. 09/699,823, filed Oct. 30, 2000 which claimed priority from U.S. Provisional Patent Application 60/236097, and U.S. patent application Ser. No. 09/699,822 filed Oct. 30, 2000.

### FIELD OF INVENTION

This invention relates to x-ray tubes incorporating a nanostructured carbon film electron emitter for use in portable x-ray spectrometry, portable fluoroscopy, and radiation treatment, and more particularly to x-ray tubes using carbon nanotubes as the electron emission source.

### DESCRIPTION OF THE RELATED ART

Heretofore, numerous methods and apparatuses have been developed for x-ray generation. For a number of years, apparatuses have been manufactured using x-ray fluorescence spectrometers for elemental analysis. In these devices, the sample has been excited by emptying either a radioacative isotope or an x-ray tube. Obsolescence of the use of a radioactive isotope is discussed in U.S. Pat. No. 5,528,647 which describes a method for using an x-ray tube in conjunction with a filtering mechanism.

Due to increasing environmental and governmental requirements and regulations, the use of radioactive isotopes for excitation purposes has not been favored in the design of these devices. With respect to portable x-ray spectrometers, the need for a lightweight, and low cost unit have forced the continued use of radioactive isotopes as the excitation source. This has the disadvantage of both increased environmental and safety compliance issues associated with the radioactive source as well as the disadvantage of the lack of control over the excitation characteristics of the source. The inability to control the excitation parameters of the radioactive source is a hindrance for the use of the apparatus for certain applications where excitation selectivity is required. More recent approaches to this limitation have resulted in apparatus that no longer contains a radioactive isotope as the excitation source but employ a thermionic x-ray tube. The x-ray tube is powered by an on-board high voltage supply as well as a filament supply necessary to heat the thermionic cathode. These components are separate components linked by a high voltage cable, typically operating in a manner such that heat dissipation from the isolated anode limits extended use of the device. This also results in a unit which is much larger, heavier and more costly than portable x-ray fluorescence spectrometers which rely on radioactive isotopes for excitation. Predominately, these portable devices are limited for single purpose use, such as transition element identification and quantification for the purposes of alloy identification.

The use of low energy x-rays is commonly employed in radiation therapy. In an effort to minimize collateral tissue damage, considerable design focus has been placed on localizing the radiation only near the tissue requiring treatment. In the case of intra-cavity therapy, radioisotopes are commonly employed as this enables small amounts of material to be placed near the treated area. However, radioisotopes present several limitations, which this invention addresses. Firstly, as an x-ray tube can be controlled, the exact amount of energy desired can be delivered to the treated area. However, x-ray tubes are not commonly found in intra-cavity therapy, as they are too big, require multiple sources of power for both the filament and high voltage, and generate too much heat, causing collateral tissue damage. This invention eliminates the need for the filament supply and furthermore allows for a very small x-ray tube to be produced which generates sufficient low energy x-rays without unnecessary heat generation caused by the thermionic cathode structure. Secondly the use of a small x-ray tube for radiation therapy allows for multiple uses of the same device, eliminating the need for replacement. Finally, as the device only produces radiation when energized, handling and regulation requirements are substantially reduced.

One of the essential requirements for a brachytheropy x-ray tube is that no part of the exterior of the tube reach a higher temperature than 40 C. This is necessary to prevent damage to tissue in immediate contact with the tube. To hold the exterior of the tube to that low temperature the heat generated at the x-ray target the by the intercepted electron beam must be removed from the quickly and efficiently. Another requirement is that the exterior of the x-ray tube and any connecting tubes or cables must be at zero (ground) potential to prevent exposure of surrounding tissue from electric fields and currents. Satisfying these requirements in very small tubes requires integration of the x-ray tube components with a cooling system to provide an effective therapeutic x-ray dose in a reasonable treatment time.

Accordingly, it is the primary object of this invention to provide a cold emitter x-ray tube using a nanostructured carbon film or carbon nanotubes as the electron emission source in such an x-ray tube. The advantage of this objective lies in the elimination of the heat requiring thermionic cathode. This allows for a total smaller package of the high voltage power supply and x-ray tube, as well as a device which generates less heat as the nanostructured carbon film or carbon nanotubes emits sufficient electrons at or near room temperature. Other objects and advantages include providing an x-ray tube using a nanostructured carbon film or carbon nanotubes coated on the internal structure of the x-ray tube at ground potential. This allows for the x-ray tube to generate sufficient x-ray flux while retaining the heat within the x-ray tube. In this fashion, the external temperature of the x-ray tube remains at or near room temperature and prevents tissue damage due to excessive heat.

Additional objects and advantages of the invention will be set forth in the description which follows, and in part will be obvious from the description, or may be learned by practice of the invention. The objects and advantages of the invention may be realized and obtained by means of the methods and combinations particularly pointed out in the appended claims.

### BRIEF SUMMARY OF THE INVENTION

A cold emitter x-ray tube is provided comprised of a cathode which is preferably a carbon nanotube or nanostructured carbon film which serves as the electron emission source in an x-ray tube, and is positioned on a suitable substrate. A metal anode which functions as the x-ray generating target is positioned within the x-ray tube. A high voltage source with negative contact is connected to the emitter and the positive contact connected to the anode target. This single source of high potential serves to provide the electric field, between the emitter and anode, for extracation of electrons from the emitter and to accelerate the electrons to the target for generation of x-rays. Alternatively, the x-ray tube can be operated in a bipolar manner, with the respective cathode and anode at opposite polarities. X-rays pass through a beryllium window that is an integral part of the vacuum envelope. The x-ray tube may be used for various applications such as portable x-ray spectrometry, portable fluoroscopy, radiation treatment, and the like.

### BRIEF DESCRIPTION OF THE DRAWINGS

The accompanying drawings, which are incorporated in and constitute a part of the specification, illustrate a preferred embodiment of the invention and, together with a general description given above and the detailed description of the preferred embodiment given below, serve to explain the principles of the invention.

FIG. 1 shows a cold emitter x-ray tube using a nanostructued carbon film, according to the invention.

FIG. 2 shows a cold emitter x-ray tube usingg a a nanostructured carbon film coated on an internal structure of the x-ray tube at ground potential, according to the invention.

FIG. 3 shows such an x-ray tube with the x-ray target and target post made from tungsten copper, according to the invention.

FIG. 4 shows such an x-ray tube with the x-ray target and target post made from tungsten copper with a ceramaic insulator, according to the invention.

FIG. 5 shows such an x-ray tube. miniturized, for use in intra-body and intra cavity therapy, according to the invention.

FIG. 6 shows such an x-ray tube, miniturized, and utilizing a bi-polar mode of operation, according to the invention.

FIG. 7 shows such an x-ray tube with means for adjusting the cathode to anode gap in cold cathode diode tubes, according to the invention.

FIG. 8 shows such an x-ray tube with an extraction/supression grid, according to the invention

### DESCRIPTION OF THE PREFERRED EMBODIMENTS

Reference will now be made in detail to the present preferred embodiments of the invention as illustrated in the accompanying drawings.

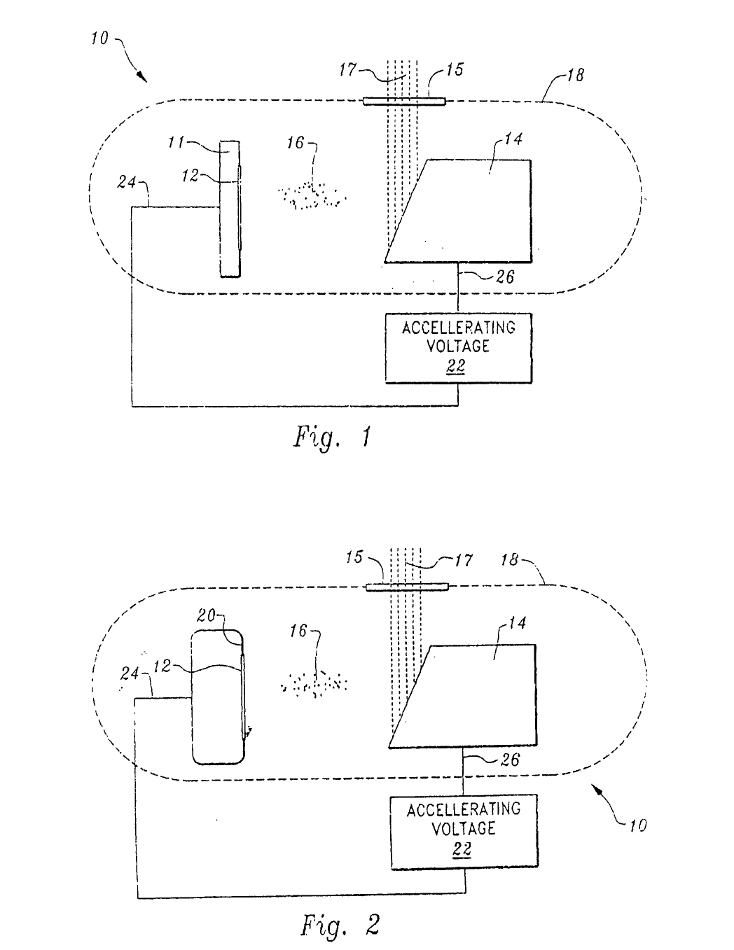

In FIG. 1, a preferred embodiment of cold emitter x-ray tube 10 is shown. X-ray tube 10, in its simplest form is a diode, as shown in FIG. 1. The diode is comprised of cathode being a carbon emitting film 12, on a suitable substrate 11, a metal anode 14 which functions as the X-ray generating target. The carbon film used for an emission cathode may, in one embodiment, comprise a layer of thin carbon film on a substrate, with 244 nm and 2-7 mW excitation, and within the wave number from 1100 to 18550 cm-1, the carbon film has a distinct UV Raman band in the range from 1578 cm-1 to 1620 cm-1 with a FWHM from 25 to 165 cm-1.

A high voltage source 22, which may be any high voltage power source, with a negative contact 24, is connected to the emitter and the positive contact 26, connected to the anode target 14. This single source of high potential serves to provide the electric field, between the emitter and anode, for extraction of the electrons 16, from the emitter and to accelerate the electrons to the target 14, for generation of x-rays. X-rays pass through the beryllium window 15, that is an integral part of the vacuum envelope 18.

Nanostructured carbon films, as used herein, are preferably composed of nanocrystalline graphite, carbon nanotubes, diamond, diamond like carbon or a composite of two or more of the above. The films are manufactured by deposition from plasma formed from a gas mixture, which contains at least one hydrocarbon gas. Carbon films are preferably deposited on glass, ceramic, metal or semiconductor substrates to form a cold, electron-emitting cathode. The electron emission mechanism is electric field assisted tunneling through the carbon film surface, or fieled emission. When placed in a high voltage field, these nanostructure carbon films emit electrons with sufficient current density to allow for the production of x-rays. With the introduction of an electron extraction grid placed between the nanostructure carbon films and the anode target, the amount of electron beam current can be accurately controlled. The entire device is sealed in a glass or metal ceramic body structure and seal under high vacuum. In this manner the device can be used without assisted pumps.

With reference now to FIG. 2, which is similar to FIG. 1, except that nanostructured film 12, is coated on an internal structure 20, of x-ray tube 10, at ground potential. X-ray tube 10, is with the diode comprised of cathode being a carbon emitting film 12, coated on an internal structure 20, of x-ray tube 10. Internal structure 20, which may be a surface of a component of x-ray tube 10, or the inner surface of vacuum envelope 18, or other positions as desired within x-ray tube 10 for a particular application. Metal anode 14, is shown which functions as the x-ray generating target and a high voltage source with negative contact connected to the emitter and the positive contact connected to the anode target. This single source of high potential serves to provide the electric field, between the emitter and anode, for extraction of the electrons 16, from the emitter, and to accelerate the electrons to the target 14, for generation of x-rays 17. X-rays 17, pass through beryllium window 15 that is an integral part of the vacuum envelope 18.

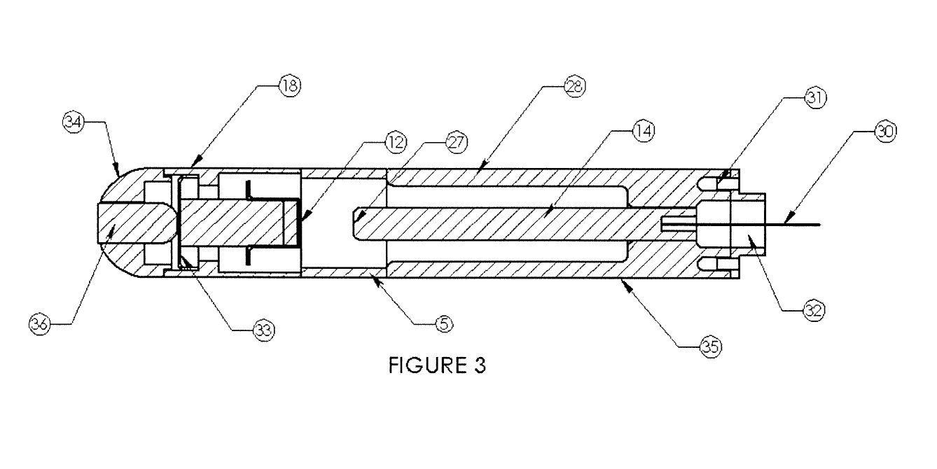

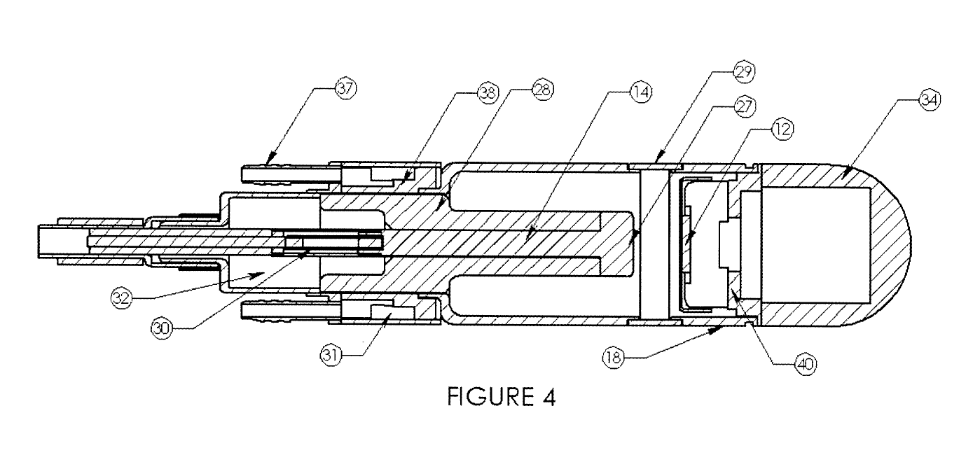

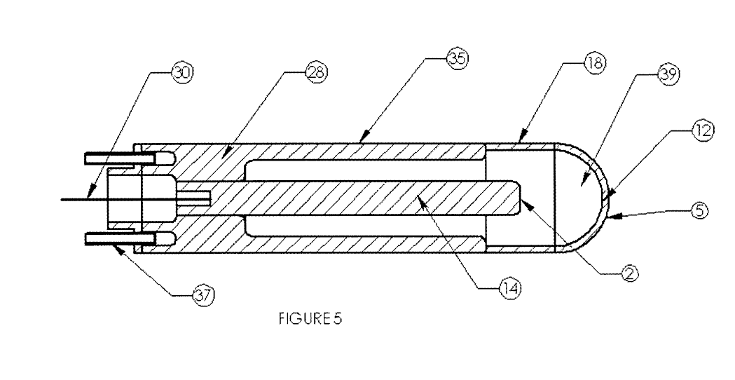

FIGS. 3 and 4 show x-ray tubes, containing a cold carbon cathode 12, in which the x-ray target 27, and the target post 14, is made from tungsten copper. This composite material is suitable for generating high x-ray intensity and providing a high conductance path for the target heat to the heat exchanger. The ratio of tungsten to copper is chosen such that the thermal expansion of the target post exactly matches that of the ceramic high voltage insulator 28. Other alloys or composites may also be chosen depending upon the energy distribution required in the x-ray spectrum of the tube. Matching the thermal expansion rates of the target post 14, and ceramic 28, has the advantage of allowing the target post to be brazed directly to the metalized ceramic with high temperature alloys, or to an unmetalized ceramic with an active metal alloy. The target 27, can also be modified by brazing any other suitable, metal, target material to the target post to improve the x-ray spectrum for specific uses.

In operation, the heat generated by the electron beam colliding with the target 27, is conducted through the target post and the high conductance interface provided by the braze metal, thence through the ceramic 35, to the heat exchanger channels. As the temperature rises and falls the metal ceramic structure expands and contracts as one part so there is minimum stress on the joining braze that could joint to fail under extreme operating conditions or from fatigue due to temperature cycling.

In FIG. 3, the x-ray tube with a cold carbon cathode 12, is whown, in which the location and configuration of the target post 14, to the ceramic insulator 28, is suitable for generating high x-ray intensity that is optimally suited for pulsed operation. In this embodiment the target temperature may rise by several hundred degrees during the electron beam pulse and fall sharply during off period between pulses. The temperature swing is substantially lower at the location of the braze. In this embodiment, the generated x-rays pass directly through a ceramic x-ray window 29. The ceramic x-ray window acts as a low pass filter, reducing the amount of lower energy, and undesirable, x-ray flux. This tube configuration can certainly be operated continuously but is not the optimal configuration for operation with high intensity beams.

With reference now to FIG. 4, a preferred configuration of target 27, to insulator ceramic 28, for continuous operation is shown. In this case the braze material extends the entire length of the target post 14. In this manner, both the target post and the ceramic conduct heat to the heat exchanger surfaces 38, resulting in lower overall internal temperatures.

In FIG. 5, a very small cold cathode x-ray tube is shown, intended for use in intra body and intra cavity therapy. Tubes used in these medical applications are desired to be less than 4 mm in diameter and less than 2 cm in length. Realization of very small x-ray tubes is greatly aided by combining more than one of necessary functions required for successful operation into individual parts used to construct the tube. It is integrated here with the liquid cooling and heat conducting features depicted in FIG. 5. The result is reduced parts count and simplified construction.

In the embodiment seen in FIG. 5,, the carbon electron emitting film is deposited on the inner, concave surface 29, of the x-ray transmission window 39, and serves as the cathode for the tube. The electrons are emitted into the converging electric field between the cathode 12, window 39, and the target 27. The electrons are focused and accelerated toward the target by the electric field. X-rays are generated when the electrons strike the target 27, and are emitted back through the window 29, as a divergent beam of x-rays. By controlling the curvature of the window/emitting surface, and the amount of area coated with the nanostructured film, the electron spot of the anode target can be controlled.

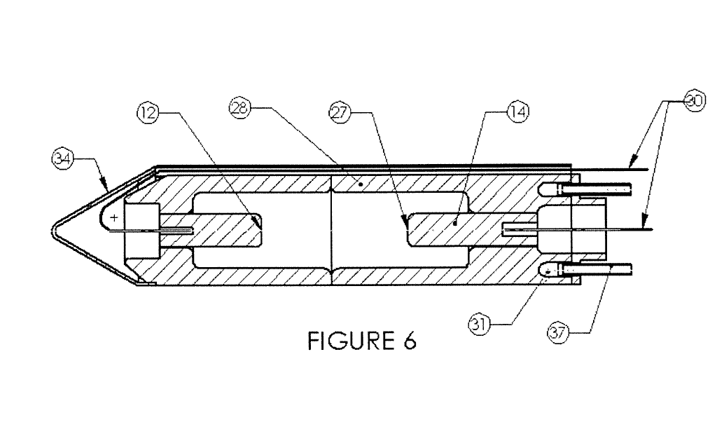

FIG. 6 shows a miniturized cold cathode x-ray tube intended for use is intra body and intra cavity therapy. X-ray tubes used in such medical applications are desired to be less than 4 mm in diameter and less than 2 cmin length. Realization of this embodiment is made possible by the use of a bi-polar mode of operation. In this embodiment, the cold cathode 12, is placed at either a positive or negative potential, while the anode 14, is place at a corresponding opposite polarity. Thus, to achieve a typical 50 kV mode of operation, the cathode 12, is placed at +25 kV, while the anode 14, is placed at −25 kV. This mode of operation is also possible if the cathode 12 is placed at −25 kV, while the anode 14, is placed at +25 kV. FIG. 6 further shows the insulating ceramic 28, the W anode target 27, the high voltage lead 30, connected to the distal end of the x-ray tube, with a second high voltage lead 30, connected to the proximal end of the x-ray tube. The water channel 31, is connected to the water tubing 37, to aidin heat dissipation of the heat generated by the x-ray production process at the anode target 27

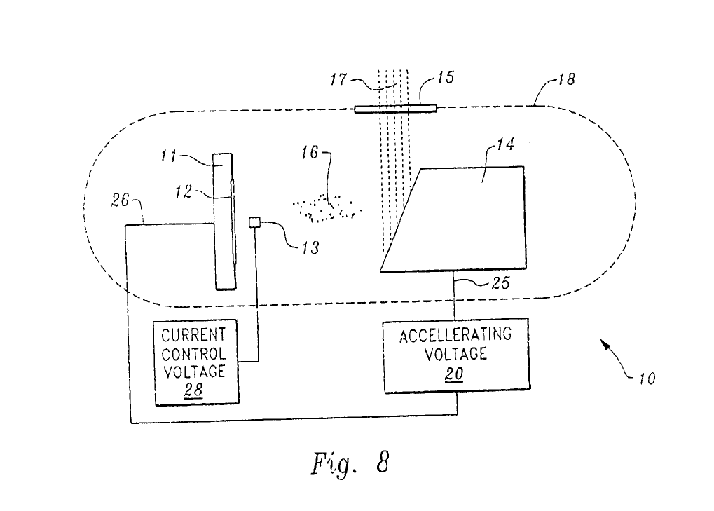

With reference now to FIG. 8, an extraction/suppression grid is shown incorporated within x-ray tube 10. Nanostructured film 12, is preferably coated on an internal structure 20, of x-ray tube 10, at ground potential. X-ray tube 10 is with the diode comprised of a cathode being a carbon emitting film 12, coated on an internal structure 20, of x-ray tube 10. Internal structure 20, which may be a surface of a component of x-ray tube 10, or the inner surface of vacuum envelope 18, or other positions as desired within x-ray tube 10 for a particular application. Metal anode 14 is shown which functions as the x-ray generating target and a high voltage source with negative contact connected to the emitter and the positive contact connected to the anode target. This single source of high potential serves to provide the electric field, between the emitter and anode, for extraction of electrons 16, from the emitter and to accelerate the electrons to the target 14, for generation of x-rays 17. X-rays 17 pass through a beryllium window 15 that is an integral part of the vacuum envelope 18.

In this embodiment, the carbon electron emitting film 12, as shown in FIG. 3, can be attenuated using an extraction grid or suppression grid placed between the electron emission source 12, and the target anode 27. FIG. 8 schematically represents this embodiment with the extraction grid or suppression grid controlled by a voltage 20, independent of the high voltage source 28. By raising the voltage from 0 volts DV to ˜1000 VDC, the grid functions as an extraction grid. In this manner the electrons are accelerated towards the high voltage field 16. The advantage of this grid is the ability to increase the anode to cathode gap, thereby allowing for higher operation potentials in a smaller form factor. Another advantage of this control grid is the ability to control the emission current, and thus x-ray output flux, independent of the applied high voltage. Another advantage of the control gird is the ability to protect the cold cathode 12, during high voltage processing.

Means are provided for adjusting the cathode to anode gap in a cold cathode diode tubes, for fixing the exact current to voltage ratio for a vacuum diode with a cold carbon based cathode. Preferably, an adjustable metal diaphragm or bellows allows the cold cathode to be moved closer or further from the anode without interrupting the vacuum envelope of the tube. The thickness and physical characteristics of the metal can be chosen such that it will retain its deformed position once the force and fixtures used to move it is removed.

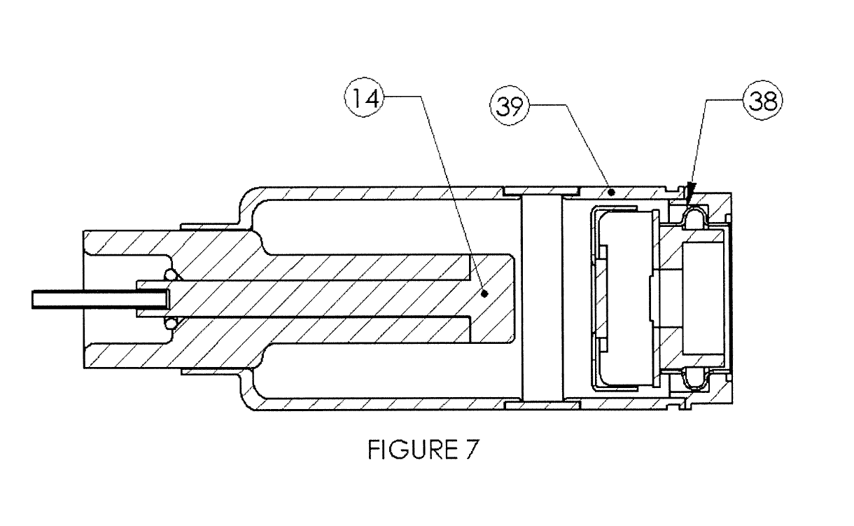

In FIG. 7, a preferred embodiment is illustrated, as applied to a cold carbon cathode x-ray tube. In practice the tube including the bellows 38, is first tested to determine whether the voltage to current ratio is above or below the desired value. If adjustment is required a fixture is installed that grips the portion of the vacuum envelope 39, on which the anode 14, is mounted and a force is applied to the deformable member 38, to set it to the desired position. This adjustment can be made with the voltages applied to allow viewing the voltage current ratio during the adjustment process. The adjustment means can also be incorporated as part of the tube, however, it adds parts to the assembly that have no function in the end application for the tube.

As seen in FIG. 3, the present invention as applied to a very small x-ray tube is shown. In this case the deformable member is a diaphragm 33 and the dimensions of the tube are so small that it impractical to use a screw to apply the moving force. In this embodiment the cold cathode 12, to anode 27, gap would always be set to a greater distance than desired, that is, a higher voltage to current ratio. The adjustment of the voltage to current ratio to the desired value is then always in one direction.

Using the present invention, a method of gettering residual gasses in small, cold cathode, x-ray tubes is also possible. The limited volume in very small x-ray tubes makes it difficult to employ evaporable getters for scavenging the residual gas from the tube as is the practice in larger tubes. Non-evaporable getters cannot be used unless some means is provided to prevent them from being saturated by absorbing gasses while the tube is being assembled and processed. This invention places the non-evaporable getter material in a cavity 40, seen in FIG. 4, with a very small aperture between the volume of the tube and the getter cavity. The cavity may be made a small capsule or be included in one of the tube components. The small aperture restricts the flow of gasses into the getter cavity to restrict it from being saturated during the assembly and processing of the tube. After the tube is assembled and sealed the getter will continue to absorb gasses from the tube at a rate determined by the size of the aperture.

In operation and use, the cold emitter x-ray tube of the present invention is extremely safe and environmentally clean. It may be used in a wide variety of applications including portable x-ray spectrometry, portable fluoroscopy, and radiation therapy, and the like.

As is evident from the above description, a wide variety of applications and systems may be envisioned from the disclosure provided. The apparatus and methods described herein are applicable in any type of x-ray tube and additional advantages and modifications will readily occur to those skilled in the art. The invention in its broader aspects is, therefore, not limited to the specific details, representative apparatus and illustrative examples shown and described. Accordingly, departures from such details may be made without departing from the spirit or scope of the applicant's general inventive concept.

What is claimed is:

18. An x-ray generating device, comprising:
a vacuum x-ray tube, said vacuum x-ray tube having a nanostructured carbon film as a cathode electron emission source secured within said vacuum x-ray tube, said nanostructured carbon film being selected from the group consisting of nanocyrstalline graphite, carbon nanotubes, diamond, diamond like carbon, or a composite of two or more of members of the group;
means for generating an electric field within said vacuum x-ray tube;
target means for generating x-rays operably positioned within said vacuum x-ray tube; and
voltage generation means for generating a voltage, said voltage generation means being operably linked to said nanostructured carbon film and said target means.

19. The x-ray generating device of claim 18, wherein said x-ray tube is a diode.

20. The x-ray generating device of claim 18, wherein said target comprises an anode target comprised of an alloy of tungsten and copper.

21. The x-ray generating device of claim 18, wherein said target comprises an anode target comprised of predominately tungsten.

22. The x-ray generating device of claim 18, wherein said x-ray generating device includes a beryllium window in a vacuum envelope allowing passage of x-rays.

23. The x-ray generating device of claim 18, wherein said x-ray generating device includes an external water cooling jacket which is removable and integrated with a high voltage insulator.

24. The x-ray generating device of claim 18, wherein said x-ray generating device includes an adjustable bellows or diaphragm to allow for repositioning of a cathode to anode distance once vacuum envelope is sealed.

25. The x-ray generating device of claim 18, wherein said x-ray generating device operates in a bi-polar manner, with a cathode at a negative potential, and an anode at a positive potential, or the cathode at a positive potential and the anode at a negative potential.

26. The x-ray generating device of claim 18, wherein said x-ray generating device operates in a uni-polar manner with a cathode at ground potential and an anode at a positive potential.

27. The x-ray generating device of claim 18, wherein said x-ray generating device operates in a uni-polar manner with a cathode at a negative potential and an anode at a ground potential.

28. The x-ray generating device of claim 18, wherein said x-ray generating device includes a vacuum envelope comprised predominately of ceramic and/or glass such that a chosen thickness of ceramic and/or glass attenuates and filters low energy x-rays.

29. The device of claim 18, wherein an extraction/suppression grid is operably positioned between said nanostructured carbon film and an anode target.

30. The device of claim 18, wherein said x-ray generating device contains a non-evaporable vacuum gettering material.

31. The device of claim 18, wherein said x-ray generating device contains an x-ray emission window which is also an electron emission source.
